(19) United States
(12) Patent Application Publication
(10) Pub. No.: US 2024/0076482 A1
(43) Pub. Date: Mar. 7, 2024

(54) COMPOSITE RESIN COMPOSITION INCLUDING COMPOSITE POLYPROPYLENE RESIN, AND MOLDED PRODUCT PRODUCED THEREFROM

(71) Applicants: Hyundai Motor Company, Seoul (KR); Kia Corporation, Seoul (KR)

(72) Inventor: Hyeong Won Park, Hwaseong (KR)

(21) Appl. No.: 18/084,285

(22) Filed: Dec. 19, 2022

(30) Foreign Application Priority Data
Sep. 1, 2022 (KR) 10-2022-0110447

(51) Int. Cl. C08L 23/12

(52) U.S. Cl. CPC C08L 23/12; C08L 2205/025; C08L 2205/03

(57) ABSTRACT

Disclosed are a composite resin composition including a composite polypropylene resin and a molded product produced therefrom. The composite resin composition includes the composite polypropylene resin including polypropylene resins each having a different melt index, a thermoplastic elastomer rubber, and a glass-based reinforcement material, thereby enabling cost reduction and weight reduction. Furthermore, even without a slip agent, the molded product produced from the composite resin composition may have good paintability, improved aesthetics due to enhanced color tones and gloss, good mechanical properties such as scratch resistance, impact resistance, and flexural modulus, and shrinkage ratio not inferior to existing materials.

### CROSS REFERENCE TO RELATED APPLICATION

The present application claims priority to Korean Patent Application No. 10-2022-0110447, filed Sep. 1, 2022, the entire contents of which is incorporated herein for all purposes by this reference.

### TECHNICAL FIELD

The present disclosure relates to a composite resin composition including a composite polypropylene resin and to a molded product produced therefrom.

### BACKGROUND

When polyamide (PA) used as a material for power electric (PE) system covers in internal-combustion-engine (ICE) vehicles is exposed to high temperature conditions for a long time, the mechanical properties thereof deteriorate. To solve this problem, polyamide used for PE system covers are required to initially have excessively good properties.

On the other hand, recently, mainstream vehicles have been shifting from ICE vehicles to electric vehicles (EVs). In order to reduce the high cost of polyamide and PE system covers in electric vehicles are in less temperature than their counterpart in ICE vehicles, research on changing a material for PE system covers from polyamide (PA) to polypropylene (PP), which has a relatively affordable price, has been conducted.

However, since the PP-based PE system covers contain a slip agent, there are many problems. For example, the slip agent makes coating difficult by causing peeling on the surface to be coated during coating. In addition, when the PP-based PE system cover is scratched, the exposed area is large, and the color tones of the exposed and unexposed areas significantly differ, resulting in deterioration in aesthetics.

### SUMMARY

In preferred aspects, the disclosure provides a composite resin composition including: a composite polypropylene resin including a composite polypropylene resin including polypropylenes having respectively different melt indices; a thermoplastic elastomer rubber; and a glass-based reinforcement material, and a molded product produced from the composite resin composition and having good paintability and mechanical properties.

Objectives of the present disclosure are not limited to the objectives mentioned above. The above and other objectives of the present disclosure will become more apparent from the following description and will be realized by the means of the appended claims, and combinations thereof.

In an aspect, provided is a composite resin composition including: a composite polypropylene resin including a first polypropylene resin with a melt index (MI) in a range of about 40 g/10 min to 50 g/10 min measured at a temperature of 230° C. and a load of 2.16 kg, and a second polypropylene resin with an MI in a range of about 90 g/10 min to 110 g/10 min measured at a temperature of 230° C. and a load of 2.16 kg; a thermoplastic elastomer rubber; and a glass-based reinforcement material The first polypropylene resin and the secondary polypropylene resin may also be different type in physical or chemical properties such as polydispersity index (PDI) other than melt index. For example, the first resin has the PDI value different from the PDI value of the second resin by at least 5, 10, 20, 25, 30, 35, 40, 45, 60, 70, 80 or 90%.

The thermoplastic elastomer as used herein may be a rubber or rubber-like olefin resin including or formed of long chainlike molecules that are capable of recovering their original shape after being stretched.

The thermoplastic elastomer may be modified or unmodified alkyl or aliphatic chains having carbon backbones linked together by single (C—C) or double (C═C) bonds.

The glass-based reinforcement material as used herein refers to a material that is added to a mixture or matrix to improve physical properties (e.g., mechanical strength) without changing the chemical properties of the mixture or the matrix. Herein, a “glass” can be considered an inorganic product of fusion that has cooled to a rigid condition without crystallizing. For instance, a glass fiber suitably may be spun from an inorganic product of fusion that has cooled to a rigid condition without crystallizing.

A mass ratio of the first polypropylene resin to the second polypropylene resin may be in a range of about 1:1.75 to 15.50.

The composite resin composition may include an amount of about 5% to 20% by weight of the first polypropylene resin, an amount of about 35% to 76% by weight of the second polypropylene resin, an amount of about 12% to 20% by weight of the thermoplastic elastomer rubber, and an amount of about 7% to 25% by weight of the glass-based reinforcement material.

The thermoplastic elastomer rubber may have an MI in a range of about 30 g/10 min to 40 g/10 min measured at a temperature of 190° C. and a load of 2.16 kg.

The thermoplastic elastomer rubber may include one or more selected from the group consisting of ethylene-butene rubber (EBR), ethylene-propylene rubber (EPR), ethylene-propylene-diene rubber (EPDM), ethylene-octene rubber (EOR), and styrene-butadiene rubber (SBR).

The glass-based reinforcement material may include one or more selected from the group consisting of glass fiber, glass beads, glass bubbles, glass wool, and milled glass fiber (GF).

The glass beads may have an average diameter (D) in a range of about 15 μm to 30 μm.

The glass fiber may have a ratio of an average length (L) to the average diameter (D) in a range of about 200 to 250.

The composite resin composition may include an amount of about 5% to 20% by weight of the first polypropylene resin, an amount of about 35% to 76% by weight of the second polypropylene resin, an amount of about 12% to 20% by weight of the thermoplastic elastomer rubber, an amount of about 5% to 15% by weight of the glass beads, and an amount of about 2% to 10% by weight of the glass fiber, and % by weight is total weight of the composite resin composition.

In an aspect, provided is a molded product including the composite resin composition as described herein.

The molded product may be used as covers for a power electric (PE) system and a trunk.

Also provided is a vehicle including the molded product as described herein.

Other aspects of the invention are disclosed infra.

According to various exemplary embodiments of the present disclosure, the composite resin composition includes a composite polypropylene resin including polypropylene resins each having a different melt index, a thermoplastic elastomer rubber, and a glass-based reinforcement material in the form of predetermined forms in a predetermined ratio, thereby enabling cost reduction and weight reduction.

In addition, even without containing a slip agent, a molded product produced from the composite resin composition may have good paintability, improved aesthetics due to enhanced color tones and gloss, good mechanical properties such as scratch resistance, impact resistance, and flexural modulus, and shrinkage rate not inferior to existing materials.

Effects of the present disclosure are not limited to the effect mentioned above. It should be understood that the effects of the present disclosure include all the effects which can be deduced from the following description.

### DETAILED DESCRIPTION

Above objectives, other objectives, features, and advantages of the present disclosure will be readily understood from the following preferred embodiments associated with the accompanying drawings. However, the present disclosure is not limited to the embodiments described herein and may be embodied in other forms. The embodiments described herein are provided so that the disclosure can be made thorough and complete and that the spirit of the present disclosure can be fully conveyed to those skilled in the art. It will be further understood that the terms “comprises”, “includes”, or “has” when used in this specification specify the presence of stated features, regions, integers, steps, operations, elements and/or components, but do not preclude the presence or addition of one or more other features, regions, integers, steps, operations, elements, components and/or combinations thereof. It will also be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween. Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Furthermore, when a numerical range is disclosed in this specification, the range is continuous, and includes all values from the minimum value of said range to the maximum value thereof, unless otherwise indicated. Moreover, when such a range pertains to integer values, all integers including the minimum to value to the maximum value are included, unless otherwise indicated. In this specification, when a range is described for a variable, the variable will be understood to include all values within the stated range, including the stated endpoints of the range. For example, a range of “5 to 10” includes values of 5, 6, 7, 8, 9, and 10, as well as any subranges such as 6 to 10, 7 to 10, 6 to 9, and 7 to 9. It will be understood to include any value between reasonable integers within the scope of the stated range, such as 5.5, 6.5, 7.5, 5.5 to 8.5, and 6.5 to 9. In addition, for example, a range of “10% to 30%” includes values such as 10%, 11%, 12%, 13%, and all integers up to and including 30%, as well as any subranges such as 10% to 15%, 12% to 18%, and 20% to 30%. It will be understood to include any value between reasonable integers within the scope of the stated range, such as 10.5%, 15.5%, 25.5%.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Polyamide (PA) has been used as a material for power electric (PE) system covers in conventional internal-combustion-engine (ICE) vehicles and are required to initially have better properties than required for normal use, which results in increased manufacturing costs. Therefore, for the cost reduction, research on the use of relatively affordable polypropylene (PP) material for PE system covers has been conducted. However, the use of PP as the material of PE system covers may have problems such as poor paintability due to the use of a slip agent.

Hence, the inventors of the present application have intensively studied to solve such problems. Throughout the present disclosure, provided is a composite polypropylene composition including a composite polypropylene resin including polypropylene resins (first and second polypropylene resins) each having a different melt index, a thermoplastic elastomer rubber, and a glass-based reinforcement material in the form of predetermined forms in a predetermined ratio enables cost reduction and weight reduction. In addition, a molded product manufactured therefrom can have good mechanical properties such as scratch resistance, impact resistance, and flexural modulus, as well as good aesthetics, shrinkage rate, and paintability.

In an aspect, provided is a composite resin composition that includes a composite polypropylene resin including a first polypropylene resin with a melt index (MI) in a range of about 40 g/10 min to 50 g/10 min measured at a temperature of 230° C. and a load of 2.16 kg, and a second polypropylene resin with an MI in a range of about 90 g/10 min to 110 g/10 min measured at a temperature of 230° C. and a load of 2.16 kg, a thermoplastic elastomer rubber, and a glass-based reinforcement material.

The composite polypropylene resin may include a first polypropylene resin and a second polypropylene resin, the resins each having a different MI at a temperature of 230° C. and a load of 2.16 kg.

The first polypropylene resin may be a high-crystallinity polypropylene resin having the MI in the range of about 40 g/10 min to 50 g/10 min measured at a temperature of 230° C. and a load of 2.16 kg, and the second polypropylene resin may be a high-crystallinity impact polypropylene resin having the MI in the range of about 90 g/10 min to 110 g/10 min measured at a temperature of 230° C. and a load of 2.16 kg.

The impact polypropylene resin may be a copolymer polymerized with a block polymerized with polypropylene and a block polymerized with ethylene.

Thus, the high-crystallinity polypropylene resins may be used for the obtainment of good stiffness and strength as well as the formation of appearances with improved gloss and blackness. In addition, the composite polypropylene resin including the polypropylenes each having a different MI and a different form of polymerization is used for the obtainment of transparency, good impact strength as well as good ductility at the same time.

When each MI of the first and second polypropylene resins is excessively low, deviating from the above range, weld lines, whitening, and gas marks may be produced, thereby deteriorating the quality of appearance. When each MI of the first and second polypropylene resins is excessively high, a burr may be formed after injection, thereby requiring additional working times. Furthermore, mechanical strength is likely to be weakened, or gas marks are likely to be produced, thereby deteriorating the quality of appearance.

In addition, a mass ratio of the first polypropylene resin to the second polypropylene resin may be in a range of about 1:1.75 to 15.50.

When the content of the second polypropylene resins is excessively low, deviating from the above mass ratio range, impact strength may be insufficiently obtained or insufficient scratch resistance may be exhibited. When the content of the second polypropylene resins is excessively high, the quality of appearance (gloss and blackness) may be deteriorated.

Preferably, while satisfying the mass ratio, with respect to 100% by weight of the total composite resin composition, each content of the first and second polypropylene resins is about 5% to 20% by weight and about 35% to 76% by weight, respectively.

When the content of the first polypropylene resins is excessively low or the content of the second polypropylene resins is excessively high, deviating from the above content range, the quality of appearance (gloss and blackness) may be deteriorated. When the content of the first polypropylene resins is excessively high or the content of the second polypropylene resins is excessively low, impact strength may be insufficiently obtained, or insufficient scratch resistance may be exhibited.

The thermoplastic elastomer rubber, according to the present disclosure, is not particularly limited, provided that it is a rubber capable of improving paintability and reinforcing impact strength of a molded product produced from the composition.

The thermoplastic elastomer rubber may include copolymer rubber of ethylene and α-olefin having 3 to 10 carbon atoms or styrene-butadiene rubber (SBR). The α-olefin is not limited in its composition, but may include propylene, butene, pentene, hexene, heptene, octene, and the like. More preferably, the thermoplastic elastomer rubber includes at least one selected from the group consisting of ethylene-butene rubber (EBR), ethylene-propylene rubber (EPR), ethylene-propylene-diene rubber (EPDM), ethylene-octene rubber (EOR), styrene-butadiene rubber (SBR), or combinations thereof. Even though the thermoplastic elastomer rubber is not limited to specific types, ethylene-butene rubber (EBR) having good paintability and good compatibility with composite polypropylene resin is preferably included.

The thermoplastic elastomer rubber may have an MI in a range of about 30 g/10 min to 40 g/10 min measured at a temperature of 190° C. and a load of 2.16 kg. When the MI of the thermoplastic elastomer rubber is less than the predetermined range, e.g., less than about 30 g/10 min, deviating from the above content range, weld lines, whitening, and gas marks may be produced, thereby deteriorating the quality of appearance. When the MI of the thermoplastic elastomer rubber is greater than the predetermined range, e.g., greater than about 40 g/10 min, a burr may be formed in parts after injection, thereby requiring additional working times. Furthermore, mechanical strength is likely to be weakened, or gas marks are likely to be produced, thereby deteriorating the quality of appearance.

The content of the thermoplastic elastomer rubber may be about 12% to 20% by weight with respect to 100% by weight of the total composite resin composition. When the content of the thermoplastic elastomer rubber is less than the predetermined amount, e.g., less than about 12% by weight, deviating from the above range, impact strength and paintability may be insufficient. When the content of the thermoplastic elastomer rubber is greater than the predetermined amount, e.g., greater than about 20% by weight, manufacturing costs may rise, which is economically unprofitable, and material may be scratched, so that gloss and blackness may be insufficient, thereby deteriorating the quality of appearance.

The glass-based reinforcement material is not particularly limited, provided that it is a reinforcement material capable of reinforcing mechanical properties such as strength, stiffness, impact strength, dimensional stability, quality of appearance, or scratch resistance in a molded product produced from the composition. Preferably, the content of the glass-based reinforcement material is about 7% to 25% by weight with respect to 100% by weight of the total composite resin composition.

When preparing a composition for manufacturing of existing PE system covers, there was a problem in that the paintability of a molded product, which is produced from a composition with the use of a slip agent and the like, was not good. However, according to various exemplary embodiments of the present disclosure, the glass-based reinforcement material having a relatively small exposure area, while satisfying the form of predetermined forms in a predetermined ratio, may be added to the composite resin composition, instead of the slip agent. As a result, surface hardness of the molded product produced therefrom can be improved, thereby enhancing scratch resistance and paintability.

The glass-based reinforcement material may include one or more selected from the group consisting of glass fiber, glass beads, glass bubbles, glass wool, and milled glass fibers (GF). Even though the glass-based reinforcement material is not limited to specific types, the glass fiber and glass beads that can cost-effectively reinforce physical properties as well as can improve scratch resistance and stiffness are preferably included in predetermined amounts in a manner to satisfy predetermined conditions. The glass beads may suitably have an average diameter (D) in a range of about 15 μm to 30 μm. In addition, the content of the glass beads may be about 5% to 15% by weight with respect to 100% by weight of the total composite resin composition.

When the average diameter (D) of the glass beads is less than the predetermined value, e.g., less than about 15 μm, or the content of the glass beads is less than the predetermined amount, e.g., less than about 5% by weight, deviating from the above range, stiffness and dimensional stability may be insufficient or the quality of appearance may be deteriorated. When the average diameter (D) of the glass beads is greater than the predetermined value, e.g., greater than about 15 μm or the content of the glass beads is greater than the predetermined amount, e.g., greater than about 15% by weight, the dispersibility may be weakened, thereby deteriorating dimensional stability and scratch resistance, or the quality of appearance may be deteriorated.

The glass fiber may have a ratio of an average length (L) to average diameter (D) in a range of about 200 to 250. Preferably, the glass fiber has an average length (L) in a range of about 2 mm to 4 mm, and an average diameter (D) in a range of about 0.008 mm to 0.02 mm. In addition, the content of the glass fiber may be about 2% to 10% by weight with respect to 100% by weight of the total composite resin composition.

When the ratio of an average length (L) to average diameter (D) is less than the predetermined value, e.g., having a length less than about 2 μm or diameter less than about 0.008 mm, mechanical properties may be insufficiently reinforced. When the ratio of an average length (L) to average diameter (D) is greater than the predetermined value, e.g., having a length greater than about 4 μm or diameter less than about 0.02 mm, during the injection, the fibers may be easily broken, so that the average length may also be shortened, thereby insufficiently reinforcing mechanical properties.

As a result, the composite resin composition may include the composite polypropylene resin including polypropylene resins each having the different melt index, the thermoplastic elastomer rubber, and the glass-based reinforcement material in the form of predetermined forms in a predetermined ratio, thereby enabling cost reduction and weight reduction.

Further, in an aspect, the disclosure provides a molded product including the composite resin composition.

Particularly, even without a slip agent, the molded product produced from the composite resin composition may have good paintability, improved aesthetics due to enhanced color tones and gloss, good mechanical properties such as scratch resistance, impact resistance, and flexural modulus, and shrinkage rate not inferior to existing materials.

Therefore, the molded product may be used for any covers for PE room cover and a trunk.

### EXAMPLE

The present disclosure will be described in more detail with reference to the following examples. The following examples are only examples to help the understanding of the present disclosure, and the scope of the present disclosure is not limited thereto.

### Example and Comparative Examples 1 to 15: Production of Molded Product Produced from Composite Resin Composition

Each composite resin composition was prepared in each composition ratio with reference to the following Tables 1 and 2. Then, with a 401 twin screw extruder, each molded product was prepared by extruding under each condition at a temperature of 230° C., a rotational speed of 250 rpm, and a feed rate of 50 kg/hr.

TABLE 1

| | | Compar- | Compar- | Compar- | Compar- | Compar- | Compar- | Compar- |
|---|---|---|---|---|---|---|---|---|
| Component | | ative | ative | ative | ative | ative | ative | ative |
| (% by | Exam- | Exam- | Exam- | Exam- | Exam- | Exam- | Exam- | Exam- |
| weight) | ple | ple 1 | ple 2 | ple 3 | ple 4 | ple 5 | ple 6 | ple 7 |
| Second | 53 | 75 | 65 | 65 | 55 | 60 | 50 | 40 |
| polypropylene | | | | | | | | |
| resin | | | | | | | | |
| First | 10 | 10 | 10 | 10 | 10 | 10 | 10 | 10 |
| polypropylene | | | | | | | | |
| resin | | | | | | | | |
| Thermoplastic | 20 | 5 | 5 | 5 | 5 | 20 | 20 | 20 |
| elastomer | | | | | | | | |
| rubber | | | | | | | | |
| Glass beads | 10 | 10 | 10 | 20 | 20 | 10 | 20 | 20 |
| Glass fiber | 7 | 0 | 10 | 0 | 10 | 0 | 0 | 10 |
| Total | 100 | 100 | 100 | 100 | 100 | 100 | 100 | 100 |

TABLE 2

| | Compar- | Compar- | Compar- | Compar- | Compar- | Compar- | Compar- | Compar- |
|---|---|---|---|---|---|---|---|---|
| Component | ative | ative | ative | ative | ative | ative | ative | ative |
| (% by | Exam- | Exam- | Exam- | Exam- | Exam- | Exam- | Exam- | Exam- |
| weight) | ple 8 | ple 9 | ple 10 | ple 11 | ple 12 | ple 13 | ple 14 | ple 15 |
| Second | 55 | 45 | 45 | 35 | 40 | 30 | 30 | 20 |
| polypropylene | | | | | | | | |
| resin | | | | | | | | |
| First | 30 | 30 | 30 | 30 | 30 | 30 | 30 | 30 |
| polypropylene | | | | | | | | |
| resin | | | | | | | | |
| Thermoplastic | 5 | 5 | 5 | 5 | 20 | 20 | 20 | 20 |
| elastomer | | | | | | | | |
| rubber | | | | | | | | |
| Glass beads | 10 | 10 | 20 | 20 | 10 | 10 | 20 | 20 |
| Glass fiber | 0 | 10 | 0 | 10 | 0 | 10 | 0 | 10 |
| Total | 100 | 100 | 100 | 100 | 100 | 100 | 100 | 100 |

Evaluation Standard
Melt index (MI): Melt index was measured by the method specified in ISO (International Organization for Standardization) 1133-1 measured at a temperature of 230° C. and a load of 2.16 kg. When MI is excessively low during injection, short shots may occur and an injection pressure is required to be increased, resulting in deformation of the parts after injection due to residual stress. In addition, since the flow rate of the resin is slow, the molded product is hardened before a complete molding, thereby deteriorating the aesthetics of the appearance. Specifically, since the aesthetics of the appearance are critical to the molded product, molding defects such as gas marks, silver streaks, and weld lines should not be easily observed in the appearance. Therefore, MI with at least 15 g/10 min or more is set as the acceptance standard.
Flexural Strength (FS) and Flexural Modulus (FM): Flexural strength and flexural modulus were measured by the method specified in ISO 178 (in a span of 64 mm and at a speed of 2 mm/min). FS refers to an ultimate flexural strength that a material withstands against a bending load while applying a flexural force that bends the material. FM, which is a value measured at the same time, refers to the degree to which a material withstands deformation against an applied force.
Izod impact strength: Izod impact strength was measured by the method specified in ISO 180 measured at temperatures of 23° C. and −30° C. and a capacity of 2.94 J on a notched specimen. Impact strength is a physical property related to a low temperature drop test for the parts of vehicles. The less the impact strength in the low-temperature drop test, the more likely the parts to be cracked or damaged.
Shrinkage rate: Shrinkage rate was measured by the method specified in ISO 527 [(change in end-to-end length of tensile specimen after injection/length of both ends of injection-molded specimen)×1000]. Shrinkage rate is a value indicating the degree of shrinkage of the material through the crystallization process after injection. The larger the shrinkage rate, the more likely molding defects such as sink marks and dimensional warping to occur. Specifically, since the purpose is to obtain a shrinkage rate not inferior to the existing PA6 material, a shrinkage rate in a range of 4% to 8% similar to the shrinkage rate of the existing material is preferably set as the acceptable standard.
Scratch resistance: Scratch resistance was marked as a ΔL value by measuring the blackness of a 2-mm-spaced scratch with the color meter using the Erichson method before and after evaluation (in a scratcher radius of 0.5 R and at a speed of 1000 mm/min and a load of 10 N). Specifically, a ΔL value lower than 1.2 is determined as the standard. When the ΔL value is less than 0.4, it is difficult to distinguish scratches with bare eyes, so preferably the above range is set as the acceptance standard.
Blackness: Blackness was measured with a color meter and based on a L value measured by the single-particle imaging (SPI) method. Blackness is a numerical value of contrast, in which the less the value, the nearer to black, and the higher the value, the nearer to white. Blackness is a physical property contributing to the quality of appearance of parts.
Gloss: Gloss was measured by the method specified in ISO 2813 with a glossmeter (at an angle of 60°). Gloss is a numerical value indicating the degree of reflection of a material after receiving light. The higher the value, the better it reflects the light, thereby making the material look shiny and the appearance look beautiful.
Paintability (adhesiveness): When coating a plastic material with paint, paintability is measured to determine whether the coated surface adheres to the plastic. Paintability is measured by the method specified in the internal standard (similar to ISO 2409). The lower the value, the better the adhesiveness. Specifically, depending on the limit samples and the criteria, paintability is determined within a range of M-1.0 to M-6.0, and preferably paintability in the range of M-1.0 to M-2.5 is set as the acceptable standard.

Evaluation Results

Each of the molded products including the composite resin composition was prepared according to Examples and Comparative Examples 1 to 15. Each of the molded products being produced was evaluated according to the evaluation standards, and the results are shown in Tables 3 and

TABLE 3

| | | | | Compar- | Compar- | Compar- | Compar- | Compar- | Compar- | Compar- |
|---|---|---|---|---|---|---|---|---|---|---|
| | Evaluation | | | ative | ative | ative | ative | ative | ative | ative |
| Physical | Standard | | Exam- | Exam- | Exam- | Exam- | Exam- | Exam- | Exam- | Exam- |
| property | (ISO) | Unit | ple | ple 1 | ple 2 | ple 3 | ple 4 | ple 5 | ple 6 | ple 7 |
| MI | 2.16 kg, | g/10 | 17 | 40.5 | 21.3 | 33.2 | 13.3 | 40.5 | 36 | 10.5 |
| | 230° C. | min | | | | | | | | |
| FS | SPAN64 | MPa | 45 | 39.5 | 71.3 | 36.4 | 68.9 | 28.4 | 25.9 | 51.5 |
| FM | 2 mm/min | | 1700 | 1580 | 2650 | 1690 | 2900 | 1140 | 1170 | 2150 |
| IZOD | Room | KJ/ | 8.5 | 3.5 | 6.4 | 3.1 | 6.5 | 4.4 | 3.6 | 11.5 |
| (notched) | temperature | m² | | | | | | | | |
| | −30° C. | | 4.5 | 2 | 6.2 | 1.8 | 6.2 | 2.1 | 2.1 | 6.9 |
| Shrinkage | MD | ‰ | 7 | 18.6 | 9.5 | 17.3 | 8.3 | 15.5 | 14.7 | 5.8 |
| rate | TD | | 5.4 | 19.2 | 8 | 18.6 | 8.4 | 14.7 | 14.7 | 4.5 |
| (ISO 2T) | (MD − | | 2.56 | 0.36 | 2.25 | 1.69 | 0.01 | 0.64 | 0 | 1.69 |
| | TD)\hat{ }2 | | | | | | | | | |
| Scratch | 10N | — | 0.35 | 0.43 | 0.52 | 0.6 | 0.44 | 0.26 | 0.33 | 0.24 |
| resistance | ERICHSON, | | | | | | | | | |
| | ΔL | | | | | | | | | |
| L Value | | — | 26.1 | 24.82 | 25.51 | 24.97 | 25.88 | 26.12 | 26.13 | 26.02 |
| (Blackness) | | | | | | | | | | |
| Gloss | 60° | — | 36.1 | 58.1 | 48.5 | 48.2 | 40.7 | 56.6 | 45.9 | 39 |
| | (91.2) | | | | | | | | | |
| Paintability | MS655- | M | 1.0 | 5.5 | 5.5 | 6.0 | 6.0 | 1.5 | 2.0 | 1.5 |
| (adhesiveness) | 08 | | | | | | | | | |

As shown in Table 3, in the case of Comparative Example 5, in which the content of the glass fiber did not satisfy the numerical range of the present disclosure, due to the higher shrinkage rate than that in the related art, the molded product may have defects such as dimensional warping. In addition, in the case of Comparative Example 7, in which the content of the glass beads did not satisfy the numerical range of the present disclosure, due to the low MI, the appearance was likely to be defective, thereby deteriorating aesthetics. In addition, in the case of Comparative Example 6, in which each of the contents of glass beads and the glass fiber did not satisfy the numerical range of the present disclosure, due to the greater shrinkage rate than that in the related art, the molded product may have defects such as dimensional warping. In addition, in the case of Comparative Example 2, in which the content of the thermoplastic elastomer rubber did not satisfy the numerical range of the present disclosure, due to the greater shrinkage rate than that in the related art, the molded product may have defects such as dimensional warping. Furthermore, the defects may be visible due to the high scratch resistance, and the adhesion may be weak due to the excessive paintability (adhesiveness). In addition, in each case of Comparative Examples 1, 3, and 4, in which each of the contents of the thermoplastic elastomer rubber as well as the glass fiber and/or the glass beads did not satisfy each of the numerical ranges of the present disclosure, due to the low MI, the appearance was likely to be defective, thereby deteriorating aesthetics, or due to the greater shrinkage rate than that in the related art, the molded product may have defects such as dimensional warping. Furthermore, due to the high scratch resistance, the defects may be visible with bare eyes, and due to the excessive paintability (adhesiveness), the adhesion may be weak.

TABLE 4

| | | | Compar- | Compar- | Compar- | Compar- | Compar- | Compar- | Compar- | Compar- |
|---|---|---|---|---|---|---|---|---|---|---|
| | Evaluation | | ative | ative | ative | ative | ative | ative | ative | ative |
| Physical | Standard | | Exam- | Exam- | Exam- | Exam- | Exam- | Exam- | Exam- | Exam- |
| property | (ISO) | Unit | ple 8 | ple 9 | ple 10 | ple 11 | ple 12 | ple 13 | ple 14 | ple 15 |
| MI | 2.16 kg, | g/10 | 36 | 16.4 | 31.5 | 11.9 | 34.3 | 14.1 | 22.7 | 9.9 |
| | 230° C. | min | | | | | | | | |
| FS | SPAN64 | MPa | 41.2 | 72.8 | 38.1 | 70.3 | 30.1 | 57.8 | 28.1 | 53.2 |
| FM | 2 mm/min | | 1630 | 2700 | 1770 | 2940 | 1230 | 2100 | 1260 | 2240 |
| IZOD | Room | KJ/ | 3.3 | 6.2 | 2.5 | 6.2 | 3.9 | 10.1 | 3.4 | 10.2 |
| (notched) | temperature | m² | | | | | | | | |
| | −30° C. | | 1.8 | 5.9 | 2.1 | 6 | 2.2 | 6.3 | 2.1 | 6.5 |
| Shrinkage | MD | ‰ | 19.6 | 8.7 | 18.5 | 8.8 | 14.6 | 6.5 | 13.3 | 5.7 |
| rate | TD | | 19.3 | 9.3 | 18.6 | 8.4 | 14.1 | 4.5 | 14.7 | 4.9 |
| (ISO 2T) | (MD − | | 0.09 | 0.36 | 0.01 | 0.16 | 0.25 | 4 | 1.96 | 0.64 |
| | TD)\hat{ }2 | | | | | | | | | |
| Scratch | 10N | — | 0.38 | 0.23 | 0.48 | 0.34 | 0.86 | 0.2 | 1.03 | 0.51 |
| resistance | ERICHSON, | | | | | | | | | |
| | ΔL | | | | | | | | | |
| L Value | | — | 24.92 | 25.33 | 25.17 | 25.49 | 26.08 | 26.06 | 26.05 | 26.1 |
| (Blackness) | | | | | | | | | | |
| Gloss | 60° | — | 65.6 | 53.3 | 55.3 | 46.7 | 55.9 | 48.2 | 46.3 | 37.4 |
| | (91.2) | | | | | | | | | |
| Paintability | MS655- | M | 5.5 | 5.5 | 5.5 | 5.5 | 1.5 | 1.0 | 1.5 | 1.5 |
| (adhesiveness) | 08 | | | | | | | | | |

As shown in Table 4, in the case of Comparative Example 12, in which each of the contents of the first polypropylene and the glass fiber did not satisfy each of the numerical ranges of the present disclosure, due to the greater shrinkage rate than that in the related art, the molded product may have defects such as dimensional warping. Furthermore, due to the high scratch resistance, the defects may be visible with bare eyes. In addition, in each case of Comparative Examples 8 to 11, in which each of the contents of the first polypropylene, as well as the thermoplastic elastomer rubber, the glass fiber and/or the glass beads, did not satisfy each of the numerical ranges of the present disclosure, due to the low MI, the appearance is likely to be defective, thereby deteriorating aesthetics, and due to the greater shrinkage rate than that in the related art, the molded product may have defects such as dimensional warping. Furthermore, due to the high scratch resistance, the defects may be visible with bare eyes, and due to the excessive paintability (adhesiveness), the adhesion may be weak. In addition, in Comparative Example 13, in which each of the contents of the first and second polypropylenes did not satisfy each of the numerical ranges of the present disclosure, due to the low MI, the appearance was likely to be defective, thereby deteriorating aesthetics. In addition, in the case of Comparative Example 15, in which each of the contents of the first and second polypropylenes, and the glass beads did not satisfy each of the numerical ranges of the present disclosure, due to the low MI, the appearance was likely to be defective, thereby deteriorating the aesthetics. Furthermore, due to the high scratch resistance, the defects may be visible with bare eyes. In addition, in the case of Comparative Example 14, in which each of the contents of the first and second polypropylenes, the glass beads, and the glass fiber did not satisfy each of the numerical ranges of the present disclosure, due to the greater shrinkage rate than that in the related art, the molded product may have defects such as dimensional warping. Furthermore, due to the high scratch resistance, the defects may be visible with bare eyes.

Thus, the composite resin composition, according to various exemplary embodiments of the present disclosure, includes the composite polypropylene resin including polypropylene resins each having a different melt index, a thermoplastic elastomer rubber, and a glass-based reinforcement material in the form of predetermined forms in a predetermined ratio, thereby enabling cost reduction and weight reduction. Furthermore, even without a slip agent, the molded product produced from the composite resin composition may have good paintability, improved aesthetics due to enhanced color tones and gloss, good mechanical properties such as scratch resistance, impact resistance, and flexural modulus, and shrinkage ratio not inferior to existing materials.

What is claimed is:

1. A composite resin composition comprising:
a composite polypropylene resin comprising a first polypropylene resin with a melt index (MI) in a range of about 40 g/10 min to 50 g/10 min measured at a temperature of 230° C. and a load of 2.16 kg and a second polypropylene resin with an MI in a range of about 90 g/10 min to 110 g/10 min measured at a temperature of 230° C. and a load of 2.16 kg;
a thermoplastic elastomer rubber; and
a glass-based reinforcement material.

2. The composite resin composition of claim 1, wherein a mass ratio of the first polypropylene resin to the second polypropylene resin is in a range of about 1:1.75 to 15.50.

3. The composite resin composition of claim 1, wherein the composite resin composition comprises:
an amount of about 5% to 20% by weight of the first polypropylene resin;
an amount of about 35% to 76% by weight of the second polypropylene resin;
an amount of about 12% to 20% by weight of the thermoplastic elastomer rubber; and
an amount of about 7% to 25% by weight of the glass-based reinforcement material,
% by weight are based on the total weight of the composite resin composition.

4. The composite resin composition of claim 1, wherein the thermoplastic elastomer rubber has an MI in a range of about 30 g/10 min to 40 g/10 min measured at a temperature of 190° C. and a load of 2.16 kg.

5. The composite resin composition of claim 1, wherein the thermoplastic elastomer rubber comprises ethylene-butene rubber (EBR), ethylene-propylene rubber (EPR), ethylene-propylene-diene rubber (EPDM), ethylene-octene rubber (EOR), styrene-butadiene rubber (SBR), or combination thereof.

6. The composite resin composition of claim 1, wherein the glass-based reinforcement material comprises glass fiber, glass beads, glass bubbles, glass wool, milled glass fiber (GF), or combinations thereof.

7. The composite resin composition of claim 6, wherein the glass beads have an average diameter (D) in a range of about 15 μm to 30 μm.

8. The composite resin composition of claim 6, wherein the glass fiber has a ratio of an average length (L) to the average diameter (D) in a range of about 200 to 250.

9. The composite resin composition of claim 6, wherein composite resin composition comprises:
an amount of about 5% to 20% by weight of the first polypropylene resin;
an amount of about 35% to 76% by weight of the second polypropylene resin;
an amount of about 12% to 20% by weight of the thermoplastic elastomer rubber;
an amount of about 5% to 15% by weight of the glass beads; and
an amount of about 2% to 10% by weight of the glass fiber,
% by weight are based on the total weight of the composite resin composition.

10. A molded product comprising a composite resin composition of claim 1.

11. The molded product of claim 10, wherein the molded product comprises a cover for a power electric (PE) system, a cover for a trunk, or combinations thereof.

12. A vehicle comprising a molded product of claim 10.
